(19) United States
(12) Patent Application Publication
(10) Pub. No.: US 2006/0160701 A1
(43) Pub. Date: Jul. 20, 2006

(54) Natural herbicidal agent containing momilactones A and B identified in and isolated from rice hulls

(75) Inventors: Il Min Chung, Seoul (KR); Ahmad Ateeque, Seoul (KR); Jin Seog Kim, Daejeon (KR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Konkuk University Industrial Cooperation Corp.

(21) Appl. No.: 11/128,102

(22) Filed: May 12, 2005

(30) Foreign Application Priority Data
Jan. 18, 2005 (KR) 10-2005-0004711

(51) Int. Cl. A01N 63/00

(52) U.S. Cl. 504/117

(57) ABSTRACT

Disclosed is a natural herbicidal agent including momilactones A and B, which are identified in and isolated from hulls of rice (Oryza sativa L.). The momilactones A and B inhibit the growth of duckweed (Lemna paucicostata Hegelm 381) at concentrations as low as 1 ppm, and completely inhibit the germination of seeds of three weed species, Leptochloa chinensis L., Amaranthus retroflexus L. and Cyperus difformis L., at 20 ppm.

### BACKGROUND OF THE INVENTION

1. Field of the Invention

The present invention relates to a natural herbicidal agent comprising momilactones A and B, which are identified in and isolated from hulls of rice (Oryza sativa L.). More particularly, the present invention relates to a natural herbicidal agent comprising momilactones which are identified in and isolated from rice hulls and are growth and germination inhibitors inhibiting the growth of duckweed (Lemna paucicostata Hegelm 381) and the growth of seeds of three weed species, Leptochloa chinensis L., Amaranthus retroflexus L. and Cyperus difformis L.

2. Description of the Prior Art

Plants release specific chemical substances in environments in which they inhabit, which inhibit or stimulate the growth of neighboring plants. This phenomenon is called allelopathy, and such plants are known as allelopathic plants (Bagenchi et al., Phytochemistry, 45, 1131-1133, 1997; Koitabashi et al., J. Plant Res., 110, 1-6, 1997).

A variety of plant antimicrobial compounds have been reported, which are generally classified into four groups according to expression systems: prohibiting, inhibiting, post inhibitins and phytoalexins.

Typically, plants evoke a set of defense responses when they encounter pathogens, including production of phytoalexins exerting antimicrobial activity against pathogens in tissues around areas in which the responses occur. Although the antimicrobial activity of phytoalexins is not very high, phytoalexins are highly attractive for use as low-toxic non-polluting agricultural chemicals because they are natural compounds produced by plants and are rarely residual due to their property of being readily degraded by healthy plant tissues.

In particular, among plant phytoalexins, rice phytoalexins have been actively studied. Rice phytoalexins include momilactones A and B, oryzalexins A to F, oryzalexin S, sakuranetin, oryzalic acids A and B, and oryzalides A and B.

The aforementioned chemicals can be isolated from a culture of rice according to a method disclosed in Japanese Pat. Laid-open Publication No. Heisei01-218591.

In addition, momilactones A and B, isolated from hulls of rice (Oryza sativa L., cv. Koshihikari), were identified to inhibit the growth of rice roots at less than 100 ppm (Kato et al., Tetrahederon Letters 39, 3862-3864, 1973).

Momilactone B was isolated from a culture of rice and identified as a material inhibiting the growth of rice seedlings (Kato-Naguchi et al., Physiologia Plantarum, 115, 401-405, 2002).

In addition, when derivatives of momilactones A and B were tested for inhibitory activity, all tested derivatives were demonstrated to inhibit the germination of lettuce seeds and the growth of rice roots. The strongest inhibitory activity was found in 3-hydro momilactone A and acetyl momilactone B among the derivatives of momilactones A and B (Kato et al., Phytochemistry, 16, 45-48, 1977).

Many other studies have reported the use of allelochemicals having allelopathic effects for inhibiting plant growth and germination. However, there is no research describing the inhibitory effects of momilactones on the growth of duckweed and germination of seeds of three weed species.

In this regard, the present inventors conducted thorough and intensive research into momilactones A and B and found that momilactones A and B isolated from rice hulls have inhibitory effects on the germination and growth of certain plants, leading to the present invention.

### SUMMARY OF THE INVENTION

It is therefore a major object of the present invention to provide a natural herbicidal agent comprising momilactones A and B identified in and isolated from hulls of rice (Oryza savita L.).

It is another object of the present invention to provide a natural herbicidal agent comprising momilactones A and B identified in and isolated from rice hulls, which inhibit the germination and growth of duckweed (Lemna paucicostata Hegelm 381).

It is a further object of the present invention to provide a natural herbicidal agent comprising momilactones A and B identified in and isolated from rice hulls, which inhibit the germination and growth of three weed species, Leptochloa chinensis L., Amaranthus retroflexus L. and Cyperus difformis L.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing the inhibitory effects of momilactones A and B, identified in and isolated from rice hulls, on the chlorophyll content of duckweed at various concentrations; and

FIG. 2 is a graph showing the visual injury symptoms in duckweed treated with various concentrations of momilactones A and B, identified in and isolated from rice hulls.

### DETAILED DESCRIPTION OF THE INVENTION

To accomplish the above objects, the present invention provides a natural herbicidal agent comprising momilactones A and B identified in and isolated from rice hulls as effective components.

In order to maintain basic properties as a typical herbicidal composition, the herbicidal agent according to the present invention may be mixed, within the limits not interrupting the present objects, with solid or liquid carriers, diluting agents, surfactants, and other adjuvants for formulations, which are known in the art. The herbicidal agent may be prepared in a form typical of agricultural chemicals, such as granules, emulsified concentrates, wettable powders, fluid preparations, and dry fluid preparations.

In addition to the aforementioned materials, other additives including adhesives, colloidal protectives, dispersing humectants, antifoaming agents, anticorrosives and antiseptics may be used for improving formulation properties, for example, emulsion, dispersion, spreading, combination, destruction control, stabilization of active components, fluidity enhancement, and corrosion resistance.

In addition, in order to enhance formulation characteristics, herbicidal effects, and the like, the herbicidal agent according to the present invention may be used in combination with polymers and other adjuvants, for example, casein, gelatin, albumin, glue, lignin sulfonate, sodium alginate, gum arabic, xanthan gum, carboxymethyl cellulose (CMC), methyl cellulose, hydroxyethyl cellulose, polyvinylalcohol (PVA), and polysaccharides.

The aforementioned various carriers and excipients may be used alone or in combination with other additives according to the formulation, application areas, application purpose, and the like.

The content of an active component in various formulations prepared according to the present invention may vary according to formulations. A suitable content typically ranges from 0.01% to 90% by weight, and more preferably 0.1% to 80% by weight.

In addition, a suitable application amount of the natural herbicidal agent according to the present invention may be generally determined depending on climate conditions, soil conditions, forms of chemical preparations, target crops, target weeds, application time, application methods, and the like. Typically, the application amount ranges from 0.01 to 1000 kg/ha, and more preferably 0.1 to 100 kg/ha, based on the total amount of active components. Also, the present composition may further include other insecticides, antifungal agents and plant growth regulators in order to supply a controller having a labor-reducing effect.

If desired, the herbicidal agent of the present invention may be used in combination with other insecticides, antifungal agents, plant growth regulators, herbicides, fertilizers, and the like.

A better understanding of the present invention may be obtained through the following example and test examples which are set forth to illustrate, but are not to be construed as the limit of the present invention.

### EXAMPLE

### Preparation of Growth/Germination Inhibition Solution

Momilactones were isolated from rice hulls according to a method described by Kato et al. (Kato et al., Phytochemistry, 16, 45-48, 1977).

The momilactones thus isolated and purified according to the method were dissolved in acetone containing a non-ionic surfactant, Tween-20, and diluted with ½ hunter medium, thus generating a growth/germination inhibition solution. The solution contained acetone and Tween-20 in final concentrations of 1% and 0.01% by weight, respectively. The acetone and Tween-20 were found not to cause growth or germination inhibition.

The bioactivity of extracted compounds was analyzed and confirmed according to a method suggested by Hong et al. (Hong et al., Korean J. Weed Sic., 20, 225-234, 2000).

### Test Example 1

### Bioactivity Assay Using Duckweed (Lemna Assay)

After 2 ml of the growth/germination inhibition solution, prepared in Example, was aliquotted in triplets into a 24-well plate, one duckweed plant having four fronds was transplanted into each well. The plate was incubated in a growth chamber (26° C., 14 h photoperiod, 50 μmol/m²s) for 5 days. Herbicidal activity was determined by visual scoring and by measuring the chlorophyll content.

The chlorophyll was extracted in DMSO (dimethyl sulfoxide), and absorbance was measured using a UV-VIS spectrophotometer. The chlorophyll content was determined based on the absorbance data according to a method described by Hiscox and Israelstam (Hiscox, J. D. and Israelstam, G. F., Can. J. Bot., 57, 1332-1334, 1979).

The inhibitory effects of the compounds on chlorophyll content in duckweed were expressed as a percentage (%) of the corresponding values obtained for a control. In the case of visual scoring, visual injury symptoms were recorded using a rating scale ranging from 0 (no effect) to 100 (complete death).

Thus, a minus value indicates growth stimulation, and a plus value indicates growth inhibition.
Chlorophyll content (μg/ml)=2.367×(absorbance)²+6.299×absorbance+0.169 (r=0.999)
Inhibition of chlorophyll content (%)=[(control-test group)/control]×100

### Test Example 2

### Germination Assay in Culture Tube (GACT)

Seeds of three weed species, Leptochloa chinensis L., Amaranthus retroflexus L. and Cyperus difformis L., which were collected on October 2002 and stored at −35° C. after floating matter was removed using distilled water, were used in this test.

The weed seeds were surface-sterilized in a 1:10 (v/v) dilution of an aqueous hypochlorite solution for 10 min and washed with distilled water several times according to a method described by Choi et al. (CHOI, J. S. et al., Korean J. Weed Sci., 22, 339-413, 2002).

650 mg of sea sand was placed into disposable culture tubes (12×75 mm), which contained the growth/germination inhibition solution at concentrations of 4, 20, 100 and 1000 ppm. 2 mg of each seed of the three weed species was added to the tubes, and was then incubated in a growth chamber (25° C., 12 h photoperiod, 20 μmol/m²s).

After seven days, percentage germination of the weed seeds was determined. Using the percentage germination, the inhibitory effects of the growth/germination inhibition solution on germination and fresh weight of the seeds were evaluated.
Germination inhibition (%)=[(control−test group)/control]×100
Fresh weight inhibition (%)=[(control−test group)/control]×100

### Test Example 3

### Statistical Analysis

All experiments were repeated three times using a completely randomized design. Analysis of variance for all data was undertaken using the general linear model (GLM) procedure of the SAS program (SAS Institute, 2000). The pooled mean values were separated based on least significant difference (LSD) at the 95% confidence level.

### Test Example 4

### Results

(1) Inhibitory effects of the growth/germination inhibition solution on tested plants

The results of the bioactivity assay using duckweed and the germination assay in culture tubes (GACT) on three weed species were given in Tables 1 and 2, below.

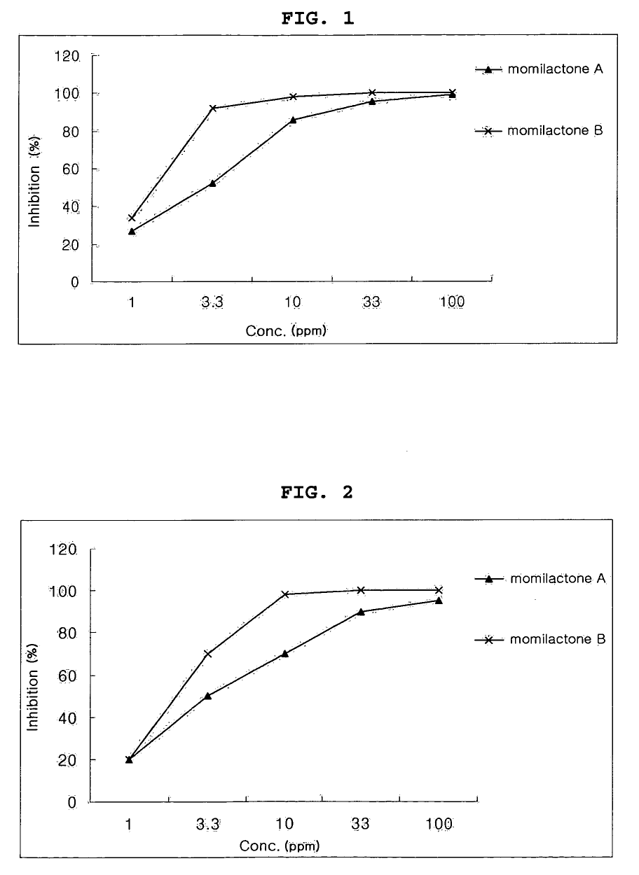

As shown in Tables 1 and FIG. 1, momilactones A and B had relatively high growth inhibitory effects against duckweed. Momilactone B was found to be more effective in inhibiting the growth of duckweed than momilactone A.

Momilactones A and B reduced chlorophyll content by 27.0, 52.3 and 85.8%, and 33.9, 91.9 and 98.3%, at 1, 3.3 and 10 ppm, respectively.

In addition, momilactone A reduced chlorophyll content by 95.6% and 98.9% at 33 and 100 ppm, respectively.

TABLE 1
Herbicidal Activity of Momilactones A and B Against Duckweed

| | | Inhibition of | Visual injury |
|---|---|---|---|
| | Concentration | chlorophyll | symptoms |
| Compounds | (ppm) | content (%) | (%) |
| Momilactone A | 100 | 98.9 | 95 |
| | 33 | 95.6 | 90 |
| | 10 | 85.8 | 70 |
| | 3.3 | 52.3 | 50 |
| | 1 | 27.0 | 20 |
| LSD (0.05) | | 6.1 | 8.6 |
| Momilactone B | 100 | 100 | 100 |
| | 33 | 100 | 100 |
| | 10 | 98.3 | 98 |
| | 3.3 | 91.9 | 70 |
| | 1 | 33.9 | 20 |
| LSD (0.05) | | 4.6 | 3.2 |

As shown in FIG. 2, in duckweed treated with 1, 3.3 and 10 ppm of momilactones A and B, visual injury was 20, 50 and 70%, and 20, 70 and 98%, respectively. Also, when duckweed was treated with 33 and 100 ppm of momilactone A, visual injury was 90% and 95%, respectively.

In contrast, treatment with 33 and 100 ppm of momilactone B resulted in complete death of duckweed, thus demonstrating that momilactone B has higher growth inhibitory effects than momilactone A.

(2) Results of Germination Assay in Culture Tube

As shown in Table 2, below, momilactones A and B had inhibitory effects on the germination and fresh weight of the three weed species at relatively high concentrations.

Momilactone B displayed higher inhibitory effects at each concentration than momilactone A, and completely inhibited the germination and growth of all tested weed species at 20 ppm.

In contrast, momilactone A showed inhibitory effects on seed germination in a wide range of 0 to 20% at 4 ppm and 30 to 100% at 100 ppm depending on the species of weeds. Also, momilactone A did not show fresh weight inhibition at concentrations at which momilactone B had inhibitory effects on weed fresh weight.

That is, the inhibitory effects of momilactone A on germination and fresh weight were highest against C. difformis and lowest against A. retroflexus.

Momilactone B showed the highest inhibitory effects against L. chinensis.

TABLE 2
Herbicidal Activity of Momilactones A and B on Seeds of Three
Weed Species

| | | Germination | | | | | |
|---|---|---|---|---|---|---|---|
| | Con- | inhibition | | | Fresh weight inhibition | | |
| | centration | (%) | | | (%) | | |
| Compounds | (ppm) | I | II | III | I | II | III |
| Momilactone A | 1000 | 100 | 100 | 100 | 100 | 100 | 100 |
| | 100 | 100 | 70 | 30 | 100 | 48.4 | 33.3 |
| | 20 | 97.5 | 0 | 20 | 100 | 0 | 18.6 |
| | 4 | 20 | 0 | 20 | 0 | 0 | 0 |
| LDS (0.5) | | 2.4 | 0.2 | 1.4 | 0 | 0.6 | 0.5 |
| Momilactone B | 1000 | 100 | 100 | 100 | 100 | 100 | 100 |
| | 100 | 100 | 100 | 100 | 100 | 100 | 100 |
| | 20 | 100 | 100 | 100 | 100 | 100 | 100 |
| | 4 | 23.3 | 100 | 15 | 15 | 23.3 | 12.5 |
| LDS (0.5) | | 4.7 | 0 | 4.7 | 4.7 | 0 | 5.2 |

Note:
I: Cyperus difformis L.;
II: Leptochloa chinensis (L.) Ness; and
III: Amaranthus retroflexus L.

While the present invention has been described in detail with reference to specific examples thereof, it will be apparent to one skilled in the art that such detailed description is only a preferred embodiment of the present invention but is not intended to limit the scope and spirit of the present invention. Therefore, the substantial scope and spirit of the present invention will be defined by the appended claims and equivalents thereof.

As described hereinbefore, the present invention provides a natural herbicidal agent comprising momilactones A and B, which have excellent allelopathic effects and are identified in and isolated from rice hulls. The herbicidal agent of the present invention may be useful for controlling duckweed and weeds.

In addition, the herbicidal agent of the present invention has an advantage of minimizing secondary contamination and adverse effects in the ecosystem because it employs environment-friendly natural materials that are extracted from a natural plant source easily obtainable on farms. With respect to recycling, the herbicidal agent has another advantage of being very cost-effective because it is prepared using discarded rice hulls.

What is claimed is:

1. A natural herbicidal agent comprising momilactones A and B, which are identified in and isolated from hulls of rice (Oryza sativa L.).

2. The natural herbicidal agent as set forth in claim 1, which inhibits germination and growth of duckweed (Lemna paucicostata Hegelm 381).

3. The natural herbicidal agent as set forth in claim 1, which inhibits germination and growth of seeds of weeds that are selected from among Leptochloa chinensis L., Amaranthus retroflexus L. and Cyperus difformis L.
